(19) United States
(12) Patent Application Publication
(10) Pub. No.: US 2008/0306953 A1
(43) Pub. Date: Dec. 11, 2008

(54) System and method for sharing resources

(75) Inventors: Scott H. Prager, Stratham, NH (US); Carl J. Kraenzel, Boston, MA (US)

Correspondence Address: HOLLAND & KNIGHT, 10 ST. JAMES AVENUE, BOSTON, MA, 02116-3889, US

(73) Assignee: International Business Machines Corporation, Armonk, NY (US)

(21) Appl. No.: 11/810,272

(22) Filed: Jun. 5, 2007

(51) Int. Cl. G06F 17/30

(52) U.S. Cl. 707/9; 707/E17.039

(57) ABSTRACT

A method and computer program product for defining an activity. One or more resources are associated with the activity. A user is associated with the activity. In response to associating the user with the activity, the user is granted access to the one or more resources associated with the activity.

### TECHNICAL FIELD

This disclosure relates to resource sharing and, more particularly, to systems and methods that share resources amongst a group of people.

### BACKGROUND

Effective collaboration and organization (as in ad-hoc processes or activity-centric computing) requires access to a variety of resources in a variety of tools and repositories. For example, creating a response to a customer RFP may leverage information in multiple locations (e.g., a customer database, one or more team rooms, and a document library) and these resources may generally have distinct controlled access (in particular when ad-hoc groups are working on a problem).

There generally are three different methodologies for addressing this problem, each of which has its own drawbacks. In a first methodology, access to each system and resource is managed manually as resources / people are added to the activity. Unfortunately, a mechanism for removing access once the activity is complete is not provided and its often unclear what access needs to be added and who controls the access to the various resources.

In a second methodology, resources are simply copied into the context of the collaborative activity (e.g., one team room may be selected as the place where all information is stored). Unfortunately, this may require duplication of data/metadata, which is unnecessary and may also lose track of future changes.

In the third methodology, a group may be manually created for the collaborative activity in question and may be added to each resource required. While this eliminates the need to address new participants, the methodology may still require manual actions to create the group and to add it to each new resource. Further, manual action may be required to remove the group when done.

### SUMMARY OF DISCLOSURE

In a first implementation, a method includes defining an activity. One or more resources are associated with the activity. A user is associated with the activity. In response to associating the user with the activity, the user is granted access to the one or more resources associated with the activity.

One or more of the following features may be included. The user may be disassociated with the activity. In response to disassociating the user with the activity, the user's access to the one or more resources associated with the activity may be restricted. Defining the activity may include defining a directory group for the activity. Associating one or more resources with the activity may include associating one or more resources with the directory group defined for the activity. Associating the user with the activity may include adding the user to the directory group defined for the activity.

The user may be disassociated with the activity. Disassociating the user with the activity may include removing the user from the directory group defined for the activity. In response to disassociating the user with the activity, the user's access to the one or more resources associated with the activity may be restricted. Granting the user access to the one or more resources associated with the activity may include interfacing with each of the one or more resources associated with the activity to grant access to each of the one or more resources associated with the activity. Restricting the user's access to the one or more resources associated with the activity may include interfacing with each of the one or more resources associated with the activity to restrict the user's access to each of the one or more resources associated with the activity.

In another implementation, a computer program product resides on a computer readable medium that has a plurality of instructions stored on it. When executed by a processor, the instructions cause the processor to perform operations including defining an activity. One or more resources are associated with the activity. A user is associated with the activity. In response to associating the user with the activity, the user is granted access to the one or more resources associated with the activity.

One or more of the following features may be included. The user may be disassociated with the activity. In response to disassociating the user with the activity, the user's access to the one or more resources associated with the activity may be restricted. Defining the activity may include defining a directory group for the activity. Associating one or more resources with the activity may include associating one or more resources with the directory group defined for the activity. Associating the user with the activity may include adding the user to the directory group defined for the activity.

The user may be disassociated with the activity. Disassociating the user with the activity may include removing the user from the directory group defined for the activity. In response to disassociating the user with the activity, the user's access to the one or more resources associated with the activity may be restricted. Granting the user access to the one or more resources associated with the activity may include interfacing with each of the one or more resources associated with the activity to grant access to each of the one or more resources associated with the activity. Restricting the user's access to the one or more resources associated with the activity may include interfacing with each of the one or more resources associated with the activity to restrict the user's access to each of the one or more resources associated with the activity.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a resource sharing process, activity server application, and an activity client application coupled to a distributed computing network;

FIG. 2 is a diagrammatic view of a display screen rendered by the resource sharing process, activity server application and/or activity client application of FIG. 1;

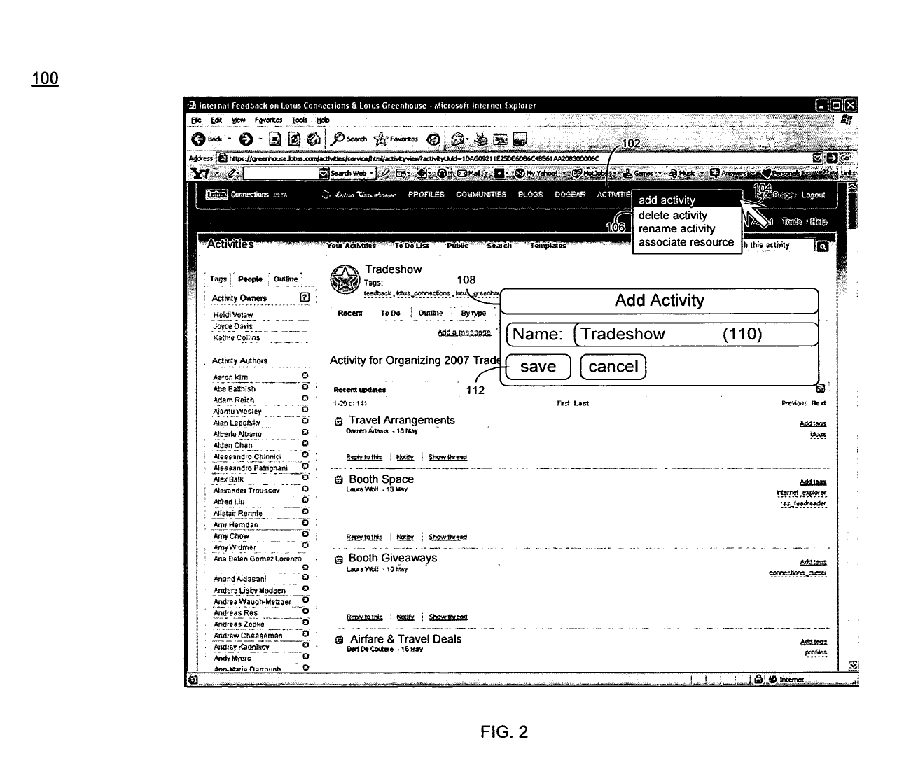

FIG. 3 is a flowchart of a process executed by the resource sharing process of FIG 1;

FIG. 4 is a diagrammatic view of a display screen rendered by the resource sharing process, activity server application and/or activity client application of FIG. 1;

FIG. 5 is a diagrammatic view of a display screen rendered by the resource sharing process, activity server application and/or activity client application of FIG. 1;

FIG. 6 is a diagrammatic view of a display screen rendered by the resource sharing process, activity server application and/or activity client application of FIG. 1;

Like reference symbols in the various drawings indicate like elements.

### DETAILED DESCRIPTION OF THE PREFERRED EMBODIMENTS

### System Overview:

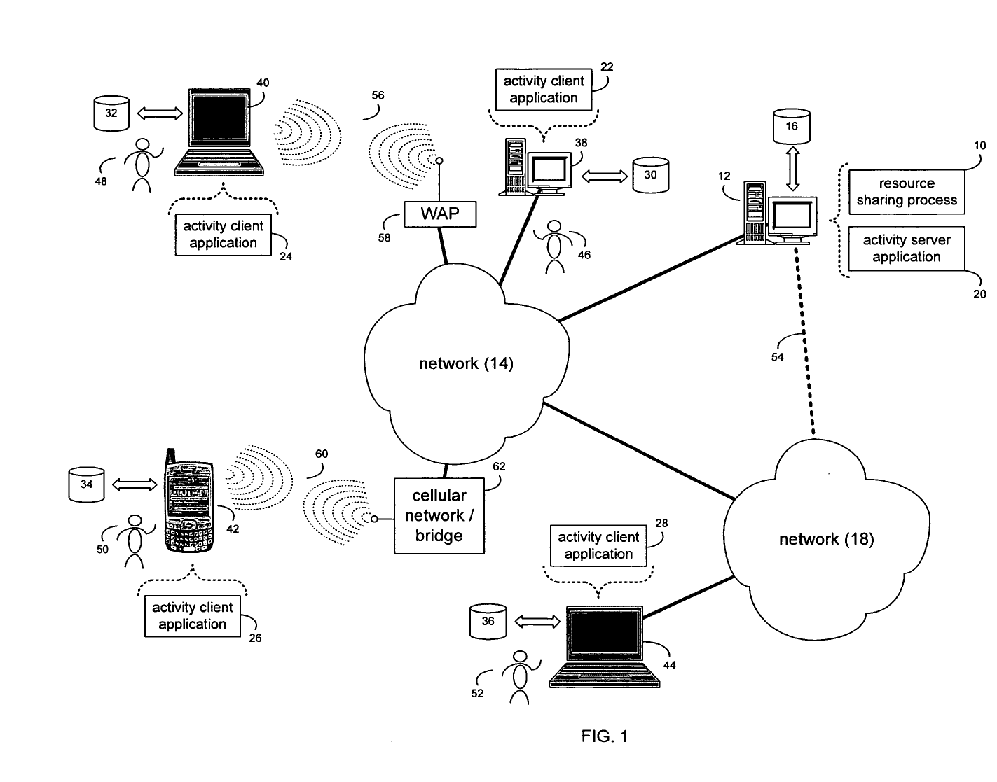

Referring to FIG. 1, there is shown resource sharing process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, resource sharing process 10 may define an activity and may associate one or more resources with the activity. A user may be associated with the activity and may be granted access to the resources associated with the activity.

The instruction sets and subroutines of resource sharing process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute activity server application 20, examples of which may include but are not limited to Lotus Connections Activities™ available from the International Business Machines Corporation of Armonk, N.Y. Activity server application 20 may allow an administrator/user to define, regulate and participate in activities (to be discussed below in greater detail) across a network and may interface with one or more activity client applications 22, 24, 26, 28, examples of which may include but are not limited to Lotus Connections Activities web client™ available from the International Business Machines Corporation of Armonk, N.Y.. Resource sharing process 10 may be a stand alone application that interfaces with activity server application 20 or an applet/application that is executed within activity server application 20.

The instruction sets and subroutines of activity server application 20, which may be stored on storage device 16 coupled to server computer 12 may be executed by one or more processors (not shown) and one or more memory architectures (not shown) incorporated into server computer 12.

The instruction sets and subroutines of activity client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of computing devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using activity client applications 22, 24, 26, 28, users 46, 48, 50, 52 may access activity server application 20 and may define, regulate and participate in activities (to be discussed below in greater detail).

Users 46, 48, 50, 52 may access activity server application 20 directly through the device on which the activity client application (e.g., activity client applications 22, 24, 26, 28) is executed, namely client electronic devices 38, 40, 42, 44, for example. Users 46, 48, 50, 52 may access activity server application 20 directly through network 14 or through secondary network 18. Further, server computer 12 (i.e., the computer that executes activity server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### The Resource Sharing Process:

Referring also to FIG.. 2, an activity client application (e.g., activity client application 22) alone or in combination with resource sharing process 10/activity server application 20 may render display screen 100. As discussed above, the activity client application (e.g., activity client application 22) may interface with activity server application 20 and may allow users to define, regulate and participate in activities.

An activity may be a collaborative event in which multiple users collaborate to achieve a common goal. For example, an activity may concern the attendance of Company X at a tradeshow. Specifically, this activity may include a plurality of discrete tasks, such as securing booth space at the tradeshow so that Company X may exhibit their goods/services. Additionally, Company X may need to make travel arrangements, arrange for the shipping of booth backdrops, platforms and tables. Further, Company X may need to have signage created and may need to obtain trinkets for giving to visitors of their booth.

Accordingly, Company X attending a tradeshow may be an activity that include a plurality of discrete tasks. As would be expected, each of these discrete task may be performed by different individuals (or different groups of individuals). However, in order to increase efficiency, it may be desirable for each individual (or group of individuals) to know what the other individuals (or groups of individuals) are doing. For example, tradeshow attendees may need to know about the travel arrangements, and the individuals making the signage may need to know about the size of the booth secured.

As would be expected, the various individuals involved in the activity may use different resources to accomplish their respective tasks. For example, the individuals securing booth space may use a corporate email resource to communicate with the producer of the tradeshow and secure the booth space. They may also use a corporate accounts payable resource to pay for the booth space. The individuals creating the signage may use a publishing resource to generate the signage. Further, the individuals arranging for the shipping of e.g., the booth backdrops, platforms and tables may need to use a corporate shipping resource.

Within the corporate environment, access to individual corporate resources may be restricted for various reasons, examples of which may include but are not limited to privacy reasons, profitability reasons, and security reasons. As will be discussed below in greater detail, resource sharing process 10 may allow access to the various resources (needed to perform an activity) to be regulated at an activity level. For example, when an individual is added to an activity, resource sharing process 10 may grant the individual access to all of the resources needed to perform the activity. Conversely, when the individual is removed from the activity (or the activity is completed), resource sharing process 10 may restrict the user's access to the various resources associated with the activity.

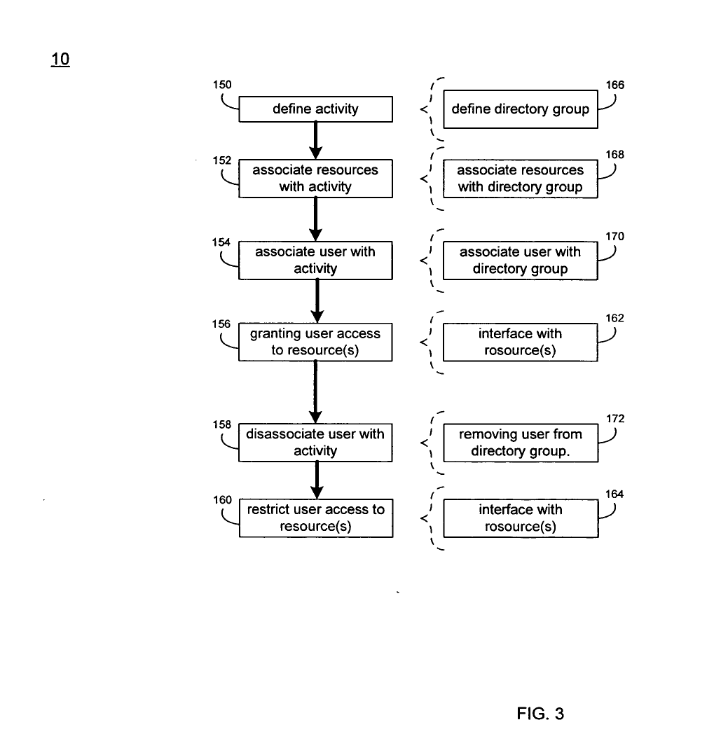

Referring also to FIG. 3, resource sharing process 10 alone or in combination with activity server application 20 may allow a user to define 150 an activity. For example, if e.g., user 46 wishes to add an activity, user 46 may select “Activities” tab 102 using onscreen pointer 104, which may be controllable by a pointing device (e.g., a mouse; not shown). Popup menu 106 may be generated, which may allow e.g., user 46 to select from various options, such as “add activity”, “delete activity”, “rename activity” and “associate resource”. Selecting “add activity” may generate popup window 108 that may allow e.g., user 46 to define 150 the activity to be added. For example, user 46 may type the name of the new activity (e.g., “Tradeshow”) into activity name field 110. Once properly named, user 46 may select “save” button 112, which may result in the generation of a new activity named “Tradeshow”.

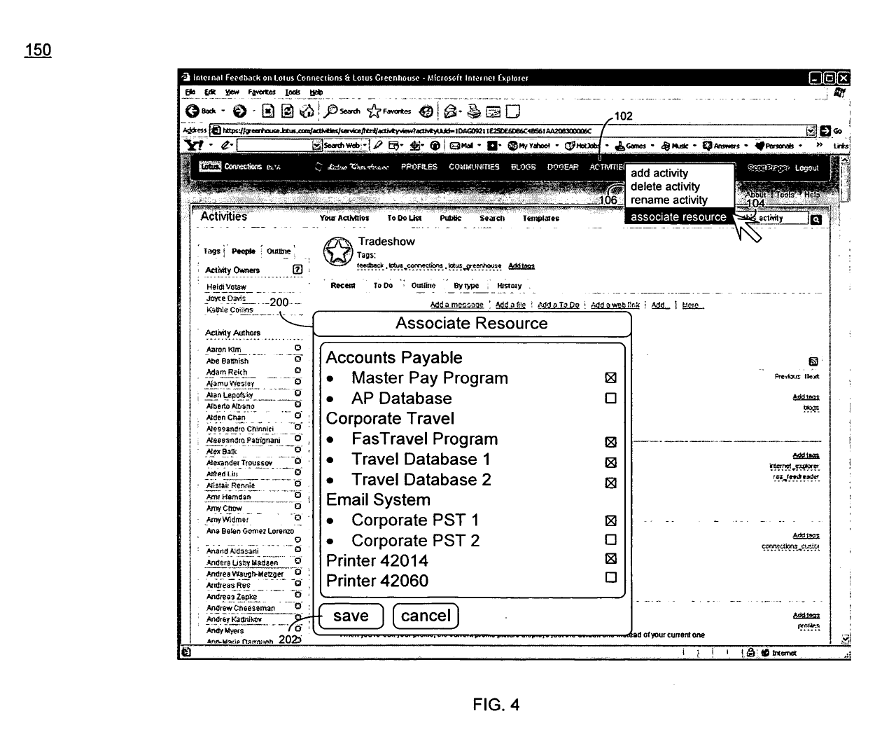

Once the activity is defined 150 by user 46, user 46 may associate 152 one or more resources with the activity. For example and referring also to FIG. 4, activity client application 22 alone or in combination with resource sharing process 10/activity server application 20 may render display screen 150, which may allow user 46 to associate 152 one of more resources with the newly-created activity “Tradeshow”. For example, if e.g., user 46 wishes to associate a resource with the newly-created activity “Tradeshow”, user 46 may select “Activities” tab 102 using onscreen pointer 104. Popup menu 106 may be generated, which may allow e.g., user 46 to select from various options, such as “add activity”, “delete activity”, “rename activity” and “associate resource”. Selecting “associate resource” may generate popup window 200 that may allow e.g., user 46 to associate 152 one or more resources with e.g., the newly-created activity “Tradeshow”.

As discussed above, examples of the types of resources available may include but are not limited to corporate email resources (e.g., a corporate email system, a corporate email database); corporate accounts payable resources (e.g., a corporate accounts payable program, a check printing machine); corporate publishing resources (e.g., a corporate publishing application, a high-end dye sublimation color printing system); corporate shipping resources (e.g., a corporate shipping program, access to third-party courier accounts); corporate travel resources (e.g., a corporate travel program, a corporate travel database); various other corporate databases; various other corporate printing devices; and various corporate websites.

For example and for illustrative purposes only, popup window 200 is shown to include three resource categories (i.e., “Accounts Payable”, “Corporate Travel”, and “Email System”), two application resources (i.e., “Master Pay Program” and “FasTravel Program”), five database resources (i.e., “AP Database”, “Travel Database 1”, “Travel Database 2”, “Corporate PST 1” and “Corporate PST 2”), and two hardware resources (i.e., “Printer 42014” and “Printer 42060”). If user 46 wishes to associate 152 a resource with e.g., newly-created activity “Tradeshow”, user 46 may select e.g., the check box associated with the resource that user 46 wishes to associate 152. For illustrative purposes, user 46 is shown to have associated 152 six resources with the newly-created activity “Tradeshow”, namely “Master Pay Program”, “FasTravel Program”, “Travel Database 1”, “Travel Database 2”, “Corporate PST 1” and “Printer 42014”. User 46 may then select “save” button 202 using onscreen pointer 104.

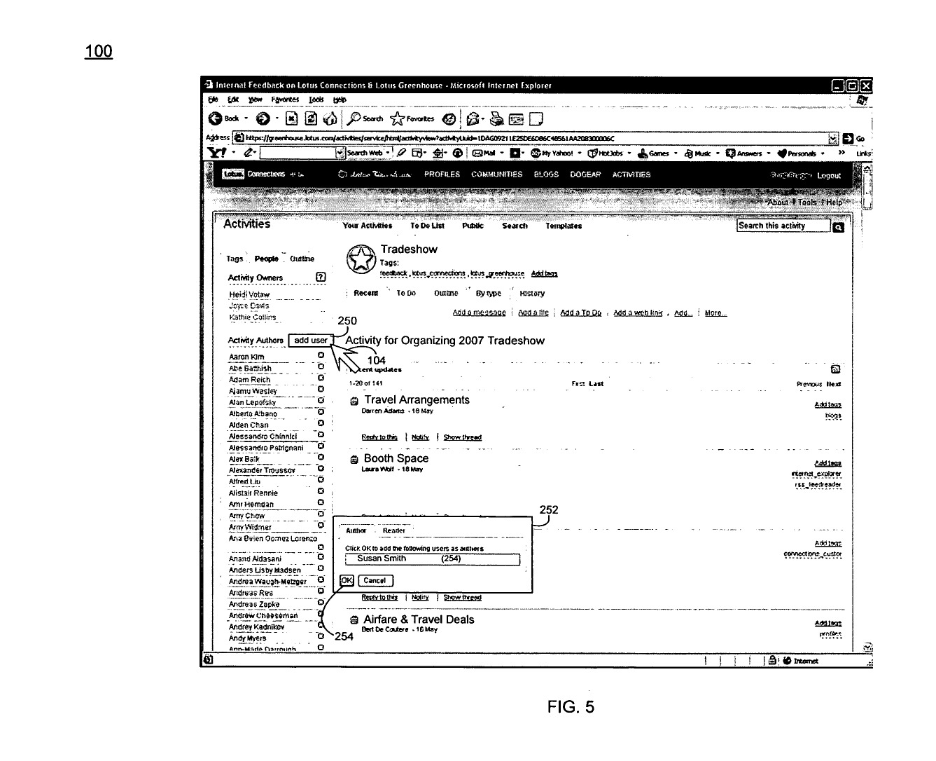

Activity client application 22 alone or in combination with resource sharing process 10/activity server application 20 may allow user 46 to associate 154 one or more users with newly-created activity “Tradeshow”. For example and referring also to FIG. 5, user 46 may select e.g., “add user” button 250 using onscreen pointer 104. Activity client application 22 alone or in combination with resource sharing process 10/activity server application 20 may render popup menu 252, that may allow user 46 to enter the name of a new user (e.g., “Susan Smith”) in name field 254. User 46 may then select (e.g., using onscreen pointer 104) “OK” button 254. In response to associating 154 the user (e.g., Susan Smith”) with the activity (e.g., newly-created activity “Tradeshow”), user 46 may be granted 156 access to the one or more resources associated with the activity (e.g., “Master Pay Program”, “FasTravel Program”, “Travel Database 1”, “Travel Database 2”, “Corporate PST 1” and “Printer 42014”).

When granting 156 the user (e.g., “Susan Smith”) access to the resources (e.g., “Master Pay Program”, “FasTravel Program”, “Travel Database 1”, “Travel Database 2”, “Corporate PST 1” and “Printer 42014”) associated 152 with newly-created activity “Tradeshow”, resource sharing process 10 may interface 162 with each of the resources (e.g., “Master Pay Program”, “FasTravel Program”, “Travel Database 1”, “Travel Database 2”, “Corporate PST 1” and “Printer 42014”) associated with newly-created activity “Tradeshow” to grant 156 access to each of the associated resources. For example, resource sharing process 10 may interface 162 with each of resources “Master Pay Program”, “FasTravel Program”, “Travel Database 1”, “Travel Database 2”, “Corporate PST 1” and “Printer 42014” to add “Susan Smith” to the list of authorized users of those resources.

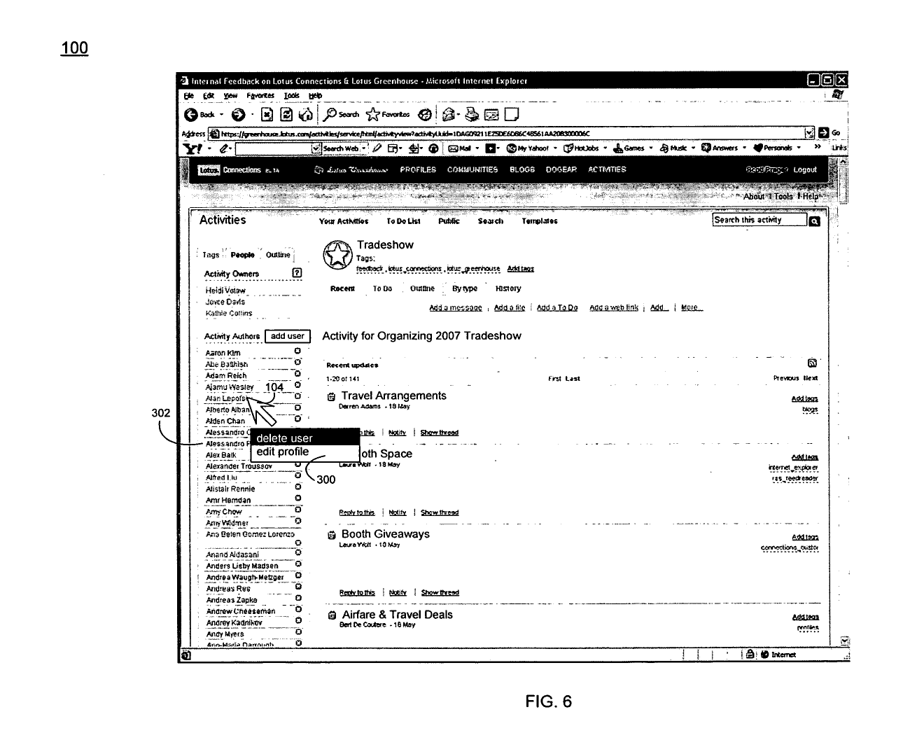

In addition to associating 154 a user with an activity, user 46 may disassociate 158 a user with the activity. For example and referring also to FIG. 6, user 46 may e.g., “right click” on the user (e.g., “Alan Lepofsky”) to be disassociated 158. Popup menu 300 may be rendered by activity client application 22 alone or in combination with resource sharing process 10/activity server application 20. User 46 may select “delete user” from popup menu 300 using e.g., onscreen pointer 104 to e.g., disassociate 158 user “Alan Lepofsky”. Once disassociated 158 with newly-created activity “Tradeshow”, user “Alan Lepofsky” may be removed from user list 302.

In response to disassociating 158 e.g., user “Alan Lepofsky” with the newly-created activity “Tradeshow”, the user's access to the resources associated with newly-created activity “Tradeshow” may be restricted 160. For example, user “Alan Lepofsky” may no longer have access to e.g., resources “Master Pay Program”, “FasTravel Program”, “Travel Database 1”, “Travel Database 2”, “Corporate PST 1” and “Printer 42014”.

Restricting 160 the access of the user (e.g., “Alan Lepofsky”) to the resources (e.g., “Master Pay Program”, “FasTravel Program”, “Travel Database 1”, “Travel Database 2”, “Corporate PST 1” and “Printer 42014”) associated with the newly-created activity “Tradeshow” may include interfacing 164 with each of the resources (e.g., “Master Pay Program”, “FasTravel Program”, “Travel Database 1”, “Travel Database 2”, “Corporate PST 1” and “Printer 42014”) associated 154 with newly-created activity “Tradeshow” to restrict 160 the access of the user (e.g., “Alan Lepofsky”) to each of the associated resources. For example, resource sharing process 10 may interface 164 with each of resources “Master Pay Program”, “FasTravel Program”, “Travel Database 1”, “Travel Database 2”, “Corporate PST 1” and “Printer 42014” to remove “Alan Lepofsky” from the list of authorized users for those resources.

Resource sharing process 10 may allow a user to manage resources through the use of directory groups. For example, defining the activity 150 may include defining 166 an directory group (not shown) for newly-created activity “Tradeshow”. A directory group may be an object maintained by activity server application 20 within a directory system (not shown). Resource sharing process 10 may allow user 46 to associate various objects together within the directory group. For example, when defining 150 activity “Tradeshow”, resource sharing process 10 (alone or in conjunction with activity server application 20) may generate a corresponding directory group “Tradeshow”, with which resource sharing process 10 may associate various resources and/or users.

When associating 152 resources with the activity “Tradeshow”, resource sharing process 10 may associate 168 the resources with the directory group defined for the activity (e.g., directory group “Tradeshow”). Accordingly, by associating 168 resources (e.g., resources “Master Pay Program”, “FasTravel Program”, “Travel Database 1”, “Travel Database 2”, “Corporate PST 1” and “Printer 42014”) with directory group “Tradeshow”, any users of directory group “Tradeshow” may be granted 156 access to the resources of the directory group (e.g., directory group “Tradeshow”).

When associating 154 users with the activity “Tradeshow”, resource sharing process 10 may associate 170 the users with the directory group defined for the activity (e.g., directory group “Tradeshow”). Accordingly, by associating 170 a user (e.g., “Susan Smith”) with directory group “Tradeshow”, user “Susan Smith” may be granted 156 access to the resources (e.g., resources “Master Pay Program”, “FasTravel Program”, “Travel Database 1”, “Travel Database 2”, “Corporate PST 1” and “Printer 42014”) of the directory group (e.g., directory group “Tradeshow”).

When managing resources through the use of directory groups, a user may be disassociated 158 with an activity by removing 172 the user from the directory group defined for the activity (e.g., directory group “Tradeshow”). In response to disassociating the user with the activity (i.e., removing 172 the user from directory group), the user's access to the resources (e.g., resources “Master Pay Program”, “FasTravel Program”, “Travel Database 1”, “Travel Database 2”, “Corporate PST 1” and “Printer 42014”) associated with the directory group (e.g., directory group “Tradeshow”) may be restricted.

While server computer 12 is illustrated in FIG. I as a single device, this is for illustrative purposes only, as other configuration are possible and are considered to be within the scope of this disclosure. As discussed above, examples of server computer 12 may include, but are not limited to: a personal computer, a server computer, a series of server computers, a mini computer, and a mainframe computer.

For illustrative purposes, server computer 12 may represent a plurality of server computers including but not limited to one or more resource servers and a directory server. The resource server (e.g., a Domino™ server) may be a server computer that stores and regulates access to the above-described resources. The same resource server (or a separate resource server) may also execute a content management system (e.g., Documentum™) that stores and regulates access to data shared amongst the members of an activity and/or a directory group. The directory server may be a server computer that manages the above-described directory groups.

A number of implementations have been described. Nevertheless, it will be understood that various modifications may be made. Accordingly, other implementations are within the scope of the following claims.

What is claimed is:

1. A method comprising:
defining an activity;
associating one or more resources with the activity;
associating a user with the activity; and
in response to associating the user with the activity, granting the user access to the one or more resources associated with the activity.

2. The method of claim 1 further comprising:
disassociating the user with the activity.

3. The method of claim 2 further comprising:
in response to disassociating the user with the activity, restricting the user's access to the one or more resources associated with the activity.

4. The method of claim 1 wherein defining the activity includes:
defining a directory group for the activity.

5. The method of claim 4 wherein associating one or more resources with the activity includes:
associating one or more resources with the directory group defined for the activity.

6. The method of claim 5 wherein associating the user with the activity includes:
adding the user to the directory group defined for the activity.

7. The method of claim 6 further comprising:
disassociating the user with the activity, wherein disassociating the user with the activity includes removing the user from the directory group defined for the activity.

8. The method of claim 7 further comprising:
in response to disassociating the user with the activity, restricting the user's access to the one or more resources associated with the activity.

9. The method of claim 1 wherein granting the user access to the one or more resources associated with the activity includes:
interfacing with each of the one or more resources associated with the activity to grant access to each of the one or more resources associated with the activity.

10. The method of claim 3 wherein restricting the user's access to the one or more resources associated with the activity includes:
interfacing with each of the one or more resources associated with the activity to restrict the user's access to each of the one or more resources associated with the activity.

11. A computer program product residing on a computer readable medium having a plurality of instructions stored thereon which, when executed by a processor, cause the processor to perform operations comprising:
defining an activity;
associating one or more resources with the activity;
associating a user with the activity; and
in response to associating the user with the activity, granting the user access to the one or more resources associated with the activity.

12. The computer program product of claim 11 further comprising instructions for:
disassociating the user with the activity.

13. The computer program product of claim 12 further comprising instructions for:
in response to disassociating the user with the activity, restricting the user's access to the one or more resources associated with the activity.

14. The computer program product of claim 11 wherein the instructions for defining the activity include instructions for:
defining a directory group for the activity.

15. The computer program product of claim 14 wherein the instructions for associating one or more resources with the activity include instructions for:
associating one or more resources with the directory group defined for the activity.

16. The computer program product of claim 15 wherein the instructions for associating the user with the activity include instructions for:
adding the user to the directory group defined for the activity.

17. The computer program product of claim 16 further comprising instructions for:
disassociating the user with the activity, wherein disassociating the user with the activity includes removing the user from the directory group defined for the activity.

18. The computer program product of claim 17 further comprising instructions for:
in response to disassociating the user with the activity, restricting the user's access to the one or more resources associated with the activity.

19. The computer program product of claim 11 wherein the instructions for granting the user access to the one or more resources associated with the activity include instructions for:
interfacing with each of the one or more resources associated with the activity to grant access to each of the one or more resources associated with the activity.

20. The computer program product of claim 13 wherein the instructions for restricting the user's access to the one or more resources associated with the activity include instructions for:
interfacing with each of the one or more resources associated with the activity to restrict the user's access to each of the one or more resources associated with the activity.
